(19) United States
(12) Patent Application Publication
(10) Pub. No.: US 2002/0095315 A1
(43) Pub. Date: Jul. 18, 2002

(54) Method and medical system for supplying a patient with medication

(75) Inventor: Thomas Redel, Poxdorf (DE)

Correspondence Address: SCHIFF HARDIN & WAITE, 6600 SEARS TOWER, 233 S WACKER DR, CHICAGO, IL, 60606-6473, US

(73) Assignee: Siemens Aktiengesellschaft

(21) Appl. No.: 10/047,713

(22) Filed: Jan. 15, 2002

(30) Foreign Application Priority Data
Jan. 15, 2001 (DE) 101 01 580.1

(51) Int. Cl. G06F 17/60

(52) U.S. Cl. 705/2

(57) ABSTRACT

In a method and a medical system for supplying a patient with medication, a designation representing a quantity and a dosage of a medication is communicated to a data bank and, at the data bank, the point in time at which the medication will be used up is calculated. The data bank establishes contact with the patient and/or a caregiver for the patient and/or a caregiving establishment for the patient prior to the point in time calculated at the data bank, so that the patient can be supplied with replenished medication before the calculated point in time.

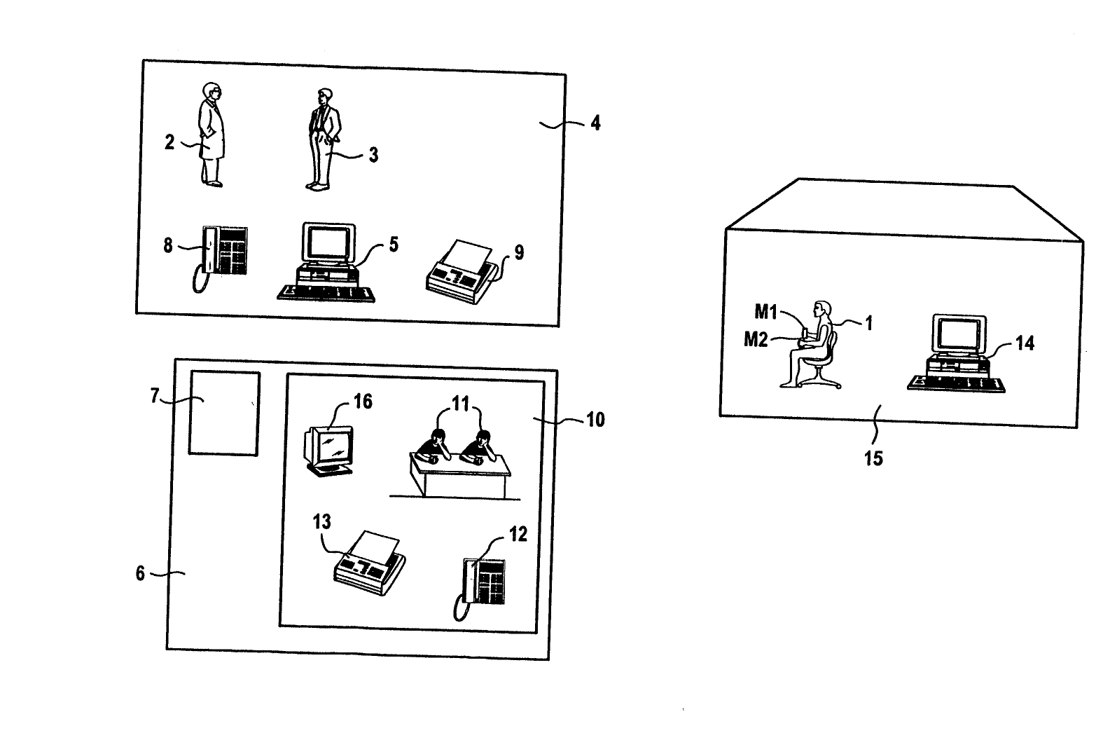

### BACKGROUND OF THE INVENTION

1. Field of the Invention

The present invention is directed to a method and a medical system for supplying a patient with medication.

2. Description of the Prior Art

During the course of a medication-based treatment, particularly for a chronically ill patient, the patient must seek out the physician treating the patient in order to be able to receive a new prescription for medication when the patient's current supply of the medication employed for the treatment has run out. In order to set up this visit to the physician in time, the patient or a person caring for the patient or a device must regularly monitor the supply of the medication. Although an electronic health assistant can be utilized, which calculates the expected time at which the medication will have been used, a coordination of doctor's appointments nonetheless remains laborious, particularly when the patient must take a number of medications, and a dependable supply to the patient with necessary medications is relatively difficult. An automatic medication dispensing device having a micro-processing device is disclosed, for example, in German OS 690 17 365. This medication dispensing device is provided for preparation and dispensing medications, particularly in a hospital. It can be designed such that it automatically reports when the amount of offered medication reaches a predetermined, lower value.

U.S. Pat. No. 5,710,551 discloses a system with which a check can be made as to whether a patient is taking a prescribed medication as prescribed. The system has a dispensing device that sends a message via a remote transmission device to a central monitoring device where the patient takes the prescribed medication from the dispensing device. Due to the messages that are sent and received from the monitoring device, an automatic check can made as to whether the patient is taking the medication as prescribed.

Another system for monitoring whether a patient is taking the prescribed medication as prescribed is disclosed in German OS 693 11 658. The system includes a portable data collecting unit and an apparatus that analyzes the collected data. Data characterizing the taking of the prescribed medication are collected with the portable data collecting unit and communicated to the device that analyzes the data. The device analyzing the data monitors whether the patient is taking the medication as prescribed on the basis of the information communicated to it.

PCT Application WO 00/07538 discloses a medication container having a code-reader device. Upon a removal of a unit of medication, the code-reader device reads out stored, medication-specific information. Together with the removal time, this information likewise serves to check whether the patient is taking the prescribed medication as prescribed.

Further, the employment of an interactive information system for preparation of therapies in the medical and psychological fields is disclosed in German PS 44 30 164. The interactive information system has at least one computer, at least one interface for connection of the computer to a private or public telephone network, a computer program for evaluating and converting the input signals that can be supplied to it via the telephone network, and at least one output device with which messages stored in digital form can be reproduced. The interactive information system asks for the identity of the patient and logs it. Subsequently, it queries person-specific and diagnosis-specific information and prepares a therapy log for the attending physician or psychologist.

Further, Japanese Application 111202651 discloses a system with which a patient can contact a physician. When the patient would like to contact a physician, names of various physicians whom the patient can contact are offered to the patient at a terminal. After the patient has selected the name, the terminal automatically connects the patient to a terminal of the selected physician.

### SUMMARY OF THE INVENTION

An object of the present invention is to provide a method and a medical system which create preconditions for assuring a dependable supply of a patient with medications.

This object is achieved in a method according to the invention for supplying a patient with medication including communicating a designation representing a quantity and a dosage of the medication to a data bank, making a calculation at the data bank, based on the designation about the quantity and the dosage of the medication, of the point in time at which the medication will have been used up, and contacting the patient and/or a person caring for the patient (caregiver) and/or a caregiving establishment based on this point in time such that a new medication can be made available to the patient in time.

In accordance with the invention, the quantity and dosing of the medication for treatment of the patient are communicated to a data bank. In the case of medication in tablet form, the quantity of the medication is the number of tablets prescribed by the attending physician. For a liquid medication, the quantity of the medical is the total volume of the unused medication. The dosage of the medication refers to the quantity of medication that the patient must regularly take for treatment, i.e., for example, the number of tablets to be taken daily. For example, the data bank can be located in a physician's practice of the physician attending the patient and, for example, can be supervised by the physician, the physician's assistant or by a customer service. In another embodiment the data bank can be operated by a service vendor. Such a service vendor can supervise the data bank and offer further services. Thus, for example, the service vendor can operate a call center to which questions from the patient, the person caring for the patient or a device caring for the patient, or from the physician, can be directed. Consequently, care of the patient can be more effectively configured and, given questions, further help can be provided quickly, in a friendly and dependable way. The quantity and dosage of the medication can be communicated to the service vendor by the patient, a caregiver or a care giving establishment responsible for care of the patient or by the physician or by one of the physician's assistance, for example by telephone or by e-mail. In an embodiment of the invention, this information is also automatically communicated from the physician's practice to the data bank. For example, a computer at the physician's practice with which a prescription for the medication is issued can automatically contact the data bank, for example via the Internet, and communicate the amount and dosage of the medication as well as the identity of the patient. It is thus assured that the data bank is always updated. Subsequently, the data bank, based on the dosage and the amount of medication, calculates the point in time at which the medication will be used up. The data bank can likewise take into consideration a residual amount (if it exists) of an as yet unconsumed mediation that was prescribed earlier. Based on the calculated point in time, the physician or one of the physician's assistance or, when the data bank is operated by a service vendor, an employee of the service vendor can contact the patient and/or the caregiver and/or care giving establishing for the patient shortly before this point in time, for example by telephone or by e-mail, in order to point out that the medication will soon be used up, so that, for example, the patient can set up an appointment with the physician. The patient or the person or establishment caring for the patient therefore need not personally monitor the supply of medication. Consequently, pre-conditions have been created so that the medication for the patient does not inadvertently run out, which would negatively affect the treatment of the patient.

In a version of the invention based on the point in time at which the medication will be used up, a physician's appointment is agreed upon with this physician for the patient. The physician's appointment is advantageously placed shortly before the time at which the medication will be used up. The physician's appointment, for example, can be agreed upon as a service by the employee of the service vendor or by the physician or by the physician's assistant.

In a further version of the invention, the data bank automatically sets up the physician's appointment. Intervening personnel such as employees of the service vendor thus are not needed.

In a further embodiment of the invention, the data bank can contact an electronic appointment calendar of the physician and, based on the information stored in the electronic appointment calendar, can set up the physician's appointment. It is thus assured that the physician is available in the automatic set up of the physician's appointment. Another advantage to the automated setting up of the physician's appointment is that no further person, nor the patient, need be concerned with setting up the physician's appointment. Consequently, setting up the physician's appointment can not be overlooked. By contacting the appointment calendar, moreover, longer times during which the physician is absent, for example due to vacation, can enter into the planning of the physician's appointment at an early time, so that, for example, a physician substituting for the attending physician can be visited. Consequently, pre-conditions have been created for scheduling the physician's appointment at a time such that the patient is reliably supplied with a new medication before the medication has been used up.

In another version of the invention, the data bank takes anytime span for which the patient is unavailable for the physician's appointment into consideration in calculating the point in time to notify the patient, the patient's caregiver, or the caregiving establishment of the need to replenish the medication. The availability of the patient is thus also assured and, in particular, one can avoid placing the physician's appointment in a time span during which the patient, for example, is traveling.

In another version of the invention the data bank automatically informs the patient and/or a person and/or entity caring for the patient of the physician's appointment. The patient or the person or device caring for the patient can be automatically informed of the physician's appointment, for example by e-mail.

In a further version of the invention the physician's appointment must be confirmed at the data bank. This assures that the patient as well as the physician reliably receive the point in time of the physician's appointment, as well as allowing the physician's appointment to be rescheduled for important reasons. The patient may have taken a smaller quantity of the medication, for example due to a longer stay in a hospital, and the data bank was not informed thereof because, for example, the patient forgot to do so or the hospital is not connected to the data bank. Consequently, the patient still has a greater remaining amount of the medication available than the data bank calculated, and the physician's appointment can ensue at a later point in time.

In another embodiment of the invention the physician is automatically informed if the patient did not have the new medication made available in time. Consequently, the physician can, for example, directly contact the patient so that the treatment of the patient is not jeopardized.

In another version of the invention if the patient takes at least one further medication and/or uses medical utensils, the data bank is informed of a quantity and dosage of the further medication or medications and/or of a quantity and a use of the medical utensils. The data bank, based on the designation of the amount and dosage of the further medication and/or medications and/or based on the designation representing the amount and of the use of the medical utensils, calculates the point in time or points in time at which the further medication or at which the further medications and/or the medical utensils is or are used up. Based on the points in time, a physician's appointment is calculated at the data bank, so that the physician can prescribe one or more new medications and/or new medical utensils for the patient in time and the number of physician's appointments is minimized. Consequently, frequent physician's appointments that lie close together in time are avoided. As a result, the patient and/or the physician saves valuable time and thus treatment costs are reduced. Medical utensils are, for example, syringes as required, for example by diabetics or swabs.

The aforementioned object of the invention also is achieved by a medical system for supplying a patient with medication having an information transmission system for the transmission of a designation about a quantity and a dosage of the medication to a data bank that includes a calculating unit for calculating the point in time at which the medication will have been used up, and a system for contacting the patient and/or a person and/or a device caring for the patient. The information transmission system can, for example, be the Internet or a telephone with which the quantity and dosage of the medication can be communicated to a person or device operating the data bank by long distance. Based on this information, the calculation unit at the data bank calculates the point in time at which the medication will be used up. Further, the medical system has a system for contacting the patient and/or a person and/or device caring for the patient. The system for contacting can, for example, be the Internet, a fax machine, a telephone, or the like. With the contacting system, the patient and/or a person and/or device caring for the patient can be informed prior to the actual time that replenishment of the medication actually will be necessary, so that the patient can have a new medication made available in time.

### DESCRIPTION OF THE DRAWING

The single FIGURE schematically illustrates a medical system constructed and operating in accordance with the principles of the present invention for supplying medication to a patient.

### DESCRIPTION OF THE PREFERRED EMBODIMENTS

The FIGURE shows a patient 1 for whom a medication M1 and a medication M2 have been prescribed by the patient's physician 2. A prescription (not shown in the FIGURE) needed for the medications M1 and M2 was issued by the physician 2, or by a person 3 supporting the physician 2, using a computer 5 at the practice (office) 4 of the physician 2. In addition to including information regarding the identity of the person 1, the prescription also contains the names, the quantities and the prescribed doses of the medications M1 and M2.

In the exemplary embodiment, the computer 5—after preparing the prescription—automatically contacts a data bank 7 operated by a service vendor 6 via an Internet connection (not shown in the FIGURE) and communicates the type, quantities and prescribed doses of the medications M1 and M2 as well as the identity of the patient 1 to the data bank 7. Particularly given a longer disruption of the Internet connection, the physician 2 or the person 3 can also communicate these particulars to a call center 10 allocated to the service vendor 6 by long distance with a telephone 8 and/or fax machine 9 allocated to the physician's practice 4 or can communicate these thereto in writing. Persons 11 work in the call center 10 who have access to a telephone 12 and fax machine 13 in the call center 10. On the basis of the communicated information, the data bank 7 automatically calculates the points in time at which the medications M1 and M2 will be used up. For calculating these points in time, the data bank 7 likewise takes any remaining amounts of medications of the same type as the medications M1 and/or M2 into consideration that the patient 1 still has at a the point in time at which the medications M1 and M2 were prescribed. Particularly when the patient 1 still has unforseen, remaining quantities of medications over, for example due to a longer stay in a hospital during which the patient 1 did not take medications prescribed by the physician 2, the information about the remaining quantity of medications from the physician 2, the person 3 or the patient 1 are communicated to the call center 10 with e-mail, by telephone or by fax, so that one of the persons 11 is capable of appropriately updating the data bank 7.

Based on the points in time, the data bank 7 plans another physician's appointment for the patient 1 such that new medications (not shown in the FIGURE) can be prescribed for the patient 1 in time before the medications M1 or M2 are used up. The new medications are of the same type as the medications M1 and M2. in the exemplary embodiment, the data bank 7—for planning the physician's appointment—automatically queries an electronic appointment calendar of the physician 2 stored on the computer 5 in order to make sure of the availability of the physician 2. In order to also make certain of the availability of the patient 1, the data bank 7 in the exemplary embodiment likewise queries an appointment calendar of the patient 1 electronically stored on a computer 14 connected to the Internet. In the present exemplary embodiment, the computer 14 is arranged in a house 15 in which the patient 1 dwells.

After the physician's appointment, which is before the time at which one of the medications M1 or M2 runs out, has been planned, the patient 1 in the exemplary embodiment is automatically informed of the physician's appointment by e-mail from the data bank 7 and is pre-noted at the physician 2 by e-mail. Before the physician's appointment can be confirmed by the physician 2, the patient 1 must confirm the physician's appointment at the data bank 7 with an e-mail, so that the data bank 7 can automatically confirm the physician's appointment on the electronic appointment calendar of the physician 2. If the patient 1 does not confirm the physician's appointment, in the exemplary embodiment one of the persons 11 of the call center 10 reminds the patient 1 of the physician's appointment by telephone approximately two weeks before the physician's appointment. If the patient 1 nonetheless does not confirm the physician's appointment, then also in the exemplary embodiment the data bank 7 automatically sends the physician 2 an e-mail about the lack of a confirmation on the part of the patient 2 when the physician's appointment passes. In particular, it is assured that the physician 2 is informed that the medication M1 and/or M2 of the patient 1 will soon be used up and the physician, if the physician considers it necessary, can communicate directly with the patient 1.

When the patient 1 keeps the physician's appointment and gets new medications prescribed from the physician 2, the data bank 7 is contacted, as already described above, so that the quantities and dosages of the new medications are communicated to the data bank 7, so that the data bank 7 can calculate a new physician's appointment.

In a departure from the method that has been described above, it is also possible for the persons 11 working in the call center 10 to monitor the points in time at which medications are used up by customers of the service vendor 6, i.e., among others, the patient 1. For example, four weeks before one of the medications M1 or M2 of the patient 1 will be used up, the call center 10 receives a corresponding indication on a monitor 16 connected to the data bank 7 in a way not shown in the FIGURE. One of the persons 11 of the call center 10 subsequently informs the patient 1 of the fact that one of the medications M1 or M2 will soon be used up. Particularly when the patient 1 can be informed by telephone, one of the persons 11 of the call center 10 can immediately set up the physician's appointment for the patient 1 essentially as a service since the data bank 7 can access the electronic appointment calendar of the physician 2. Further, one of the persons 11 can supply the patient 1 with information such as compatibility, side effects, etc., that are relevant for taking the medications M1 and M2.

If the data bank 7 cannot access the electronic appointment calendar of the physician 2, it is also possible for one of the persons 11 to set up the physician's appointment in a conventional way, by calling the physician 2 or the person 3 with the telephone 12. The physician's appointment can also be set up by the patient 1.

However, it is also conceivable that the patient 1 has access to the data bank 7 by Internet and can access an Internet page cared for by the service vendor 6 and allocated to the patient 1 and on which, for example, other information in addition to the point in time at which at least one of the medications M1 or M2 will be used up can be found, for example descriptions, dosages, efficacies, side effects, etc. of the medications M1 and M2.

It is also possible for the patient 1 to regularly contact the call center 10 by telephone, whereby one of the persons 11 informs the patient 1 that the medications M1 or M2 will be used up.

The house 15 may be a care facility or a senior's residence in which the patient 1 lives. Then, it is also possible for the call center 10 or the data bank 7 to be in contact with a person caring for the patient 1 or with a caregiving establishment caring for the patient 1 such as, for example, the care facility or senior's home.

The amount and dosage of the medications M1 and M2 also can be communicated from the patient 1 to a person and/or entity caring for the patient 1.

Further, automatically informing the physician 2 by the data bank 7 of a physician's appointment that has not been confirmed is optional. It is also possible that the call center 10 informs the physician 2.

Further, the data bank 7 need not necessarily be operated by a service vendor 6 but, in particular, can also be operated by the physician 2.

The service vendor 6 need not necessarily operate a call center 10.

An automatic contacting of the data bank by the computer 5 is likewise optional. It is also possible for the physician 2 or the person 3 to enter the data relevant for the calculation on an Internet home page of the service vendor 6.

The method or the medical system also can be employed for animals.

Instead of or in addition to the medication M1 and/or M2, medical utensils such as, for example, syringes or swabs can also be taken into consideration.

Moreover, particularly the description of two medications M1 and M2 in the above exemplary embodiment is only an example; any number can be used.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for supplying a patient with medication, comprising the steps of:
(a) communicating a designation to a data bank representing a quantity and a dosage of a medication;
(b) at said data bank, calculating, based on said designation, a point in time at which said medication will be used up; and
(c) prior to said point in time, establishing a contact from said data bank to an entity selected from the group consisting of said patient, a caregiver for said patient, and a caregiving establishment for said patient, to allow replenished medication to be available to said patient no later than said point in time.

2. A method as claimed in claim 1 comprising operating said data bank by a service vendor.

3. A method as claimed in claim 1 comprising the additional steps of prescribing said medication by a physician at a physician's practice, and automatically establishing a contact from said physician's practice to said data bank at a time of said prescription to inform the data bank of the physician responsible for prescribing said medication.

4. A method as claimed in claim 1 wherein step (c) includes setting up an appointment with said physician prior to said point in time.

5. A method as claimed in claim 4 wherein said data bank automatically sets up said physician's appointment dependent on said point in time.

6. A method as claimed in claim 5 wherein said physician has an electronic appointment calendar, and wherein the step of automatically setting up said physician's appointment comprises automatically establishing a contact from said data bank to said electronic appointment calendar to set up said physician's appointment dependent on information stored in said electronic appointment calendar.

7. A method as claimed in claim 5 wherein said patient has a time span wherein said patient is unable to participate in said physician's appointment, and wherein said data bank takes said time into account in setting up said physician's appointment.

8. A method as claimed in claim 4 wherein said data bank automatically informs said entity of said physician's appointment.

9. A method as claimed in claim 4 wherein confirmation of said physician's appointment is required at said data bank.

10. A method as claimed in claim 1 comprising the additional steps of storing information in said data bank identifying a physician responsible for prescribing said, medication, and automatically informing said physician from said data bank if replenishment of said medication cannot be made available to said patient before said point in time.

11. A method as claimed in claim 1 wherein said medication is a first medication, and wherein step (a) comprises communicating a designation representing a quantity and a dosage of a second medication to said data bank, in addition to said designation representing a quantity and a dosage of said first medication, and wherein step (b) comprises calculating, at said data bank, a point in time at which said second medication will be used up in addition to said point in time at which said first medication will be used up, and wherein step (c) comprises establishing said contact from said data bank to said entity before an earliest of said point in time at which said first medication will be used up and said point in time at which said second medication will be used up.

12. A method as claimed in claim 1 wherein step (a) comprises communication a designation of an amount and a usage of a medical utensil, associated with administration of said medication, to said data bank together with said designation representing a quantity and a dosage of said medication, and wherein step (b) comprises calculating, at said data bank, a point in time at which said medical utensil will be used up in addition to said point in time at which said medication will be used up, and wherein step (c) comprises establishing said contact from said data bank to said entity before an earliest of said point in time at which said medication will be used up and said point in time at which said medical utensil will be used up.

13. A medical system for supplying a patient with medication, comprising:
a data bank to which a designation representing a quantity and a dosage of a medication is communicated;
a calculator at said data bank which calculates, based on said designation, a point in time at which said medication will be used up; and
prior to said point in time, said data bank establishing a contact from said data bank to an entity selected from the group consisting of said patient, a caregiver for said patient, and a caregiving establishment for said patient, to allow replenished medication to be available to said patient no later than said point in time.

14. A medical system as claimed in claim 13 wherein said data bank is operated by a service vendor.

15. A medical system as claimed in claim 13 wherein said medication is prescribed by a physician at a physician's practice, and further comprising a unit at said physician's practice of automatically establishing a contact from said physician's practice to said data bank at a time of said prescription to inform said data bank of the physician responsible for prescribing said medication.

16. A medical system as claimed in claim 15 wherein said data bank initiates setting up an appointment with said physician prior to said point in time.

17. A medical system as claimed in claim 16 wherein said data bank automatically sets up said physician's appointment dependent on said point in time.

18. A medical system as claimed in claim 17 wherein said physician has an electronic appointment calendar, and wherein said data bank automatically establishes a contact from said data bank to said electronic appointment calendar to set up said physician's appointment dependent on information stored in said electronic appointment calendar.

19. A medical system as claimed in claim 17 wherein said patient has a time span wherein said patient is unable to participate in said physician's appointment, and wherein said data bank takes said time into account in setting up said physician's appointment.

20. A medical system as claimed in claim 16 wherein said data bank automatically informs said entity of said physician's appointment.

21. A medical system as claimed in claim 16 wherein said data bank requires confirmation of said physician's appointment.

22. A medical system as claimed in claim 13 wherein said data bank contains information identifying a physician responsible for prescribing said medication, and wherein said data bank automatically informs said physician replenishment of said medication cannot be made available to said patient before said point in time.

23. A medical system as claimed in claim 13 wherein said medication is a first medication, and wherein a designation representing a quantity and a dosage of a second medication is communicated to said data bank, in addition to said designation representing a quantity and a dosage of said first medication, and wherein said calculator at said data bank calculates a point in time at which said second medication will be used up in addition to said point in time at which said first medication will be used up, and wherein said data bank establishes said contact from said data bank to said entity before an earliest of said point in time at which said first medication will be used up and said point in time at which said second medication will be used up.

24. A medical system as claimed in claim 13 wherein a designation of an amount and a usage of a medical utensil, associated with administration of said medication, is communicated to said data bank together with said designation representing a quantity and a dosage of said medication, and wherein said calculator at said data bank calculates a point in time at which said medical utensil will be used up in addition to said point in time at which said medication will be used up, and wherein said data bank establishes said contact from said data bank to said entity before an earliest of said point in time at which said medication will be used up and said point in time at which said medical utensil will be used up.
